(19) United States
(12) Patent Application Publication
(10) Pub. No.: US 2007/0110932 A1
(43) Pub. Date: May 17, 2007

(54) High-barrier packaging material

(75) Inventors: Wilfred L. Castillo, Metro Manila (PH); Grace N. Mercado, Sta. Rosa (PH)

Correspondence Address: NELSON MULLINS RILEY & SCARBOROUGH, LLP, MERIDIAN, SUITE 1700, 1320 MAIN STREET, COLUMBIA, SC, 29201, US

(73) Assignee: Bristol-Myers Squibb Company

(21) Appl. No.: 11/280,912

(22) Filed: Nov. 16, 2005

(51) Int. Cl. B32B 27/10; B32B 27/40; B32B 27/32; B32B 27/36

(52) U.S. Cl. 428/34.3; 428/537.5; 428/481; 428/483; 428/523; 428/458; 428/423.1; 428/332

(57) ABSTRACT

The invention involves a high-barrier packaging material comprising at least one outer layer of kraft paper, at least one center layer of high-barrier metallized polyethylene terephthalate, and an inner layer of linear low density polyethylene. The packaging material has excellent water vapor and oxygen barrier properties.

### BACKGROUND OF THE INVENTION

(1) Field of the Invention

The present invention relates to a high-barrier packaging material.

(2) Description of the Related Art

In the packaging of certain products, such as food products in particular, it is highly desirable to impede or prevent the transmission of oxygen and/or water vapor through the packaging. While the permeation of oxygen or water vapor is not necessarily harmful to the products themselves, the quality and shelf-life of the products may deteriorate when exposed to these elements.

To prevent the deterioration of such products, plastic films are often used for packaging. One such plastic film is polyethylene terephthalate (PET), which is a polyester of terephthalic acid and ethylene glycol. PET can be obtained through the condensation of dimethyl terephthalate with ethylene glycol or through the condensation of terephthalic acid with ethylene glycol or ethylene oxide. The excellent thermal properties of PET allow processing and use over a wider temperature range (−70° C. to 150° C.) than many common packaging films.

In many situations, PET is metallized to improve its barrier properties. Metallizing is the process of applying a metallic coating onto another surface. PET can be metallized through various processes, including vacuum metallization, physical evaporation, sputtering, indirect metallization, plating, or painting. Most commonly, PET is vacuum-metallized with a layer of aluminum. In this process, the aluminum can be heated, melted and evaporated in a chamber under a high vacuum. The evaporated vapor then migrates through the chamber and condenses on cooler surfaces, such as the PET.

Metallized PET is often preferred over other metallized plastics because it has a low permeability to oxygen, other gases and water vapor. A single web of metallized PET may provide an oxygen barrier of between about 0.5 and 0.8 cm³m²/24 hours (at 23° C., 0% relative humidity (RH)) and a water vapor barrier of about 1 gm²/24 hours (at 38° C., 90% RH). Metallized PET also exhibits good flex crack resistance, tear resistance and chemical resistance. While metallized PET is a popular option in plastics packaging, it does have various disadvantages. For example, surface defects such as scratching or scuffing may occur on the metal surface of metallized PET. These surface defects are often the main channels for gas and moisture penetration.

In response to these surface defects, high-barrier metallization processes have emerged. For example, Great Britain Patent No. 2,103,999 to Bodin, et al. relates to a method of bonding two layers of metallized PET to improve both the oxygen and water vapor barrier. In one embodiment of the invention, Bodin describes the bonding of the two metallized PET layers, metal surface to metal surface. By laminating the two metallized surfaces together, the occurrence of surface defects is significantly reduced. The performance of such laminate structure is significantly improved over single layer metallized structures. For example, the water vapor barrier of a high-barrier metallized PET laminate may be between about 0.1 and 0.13 gm²/24 hours and the oxygen barrier may be about 0.6 cm³m²/24 hours.

Similarly, European Patent No. 0,154,248 to Kelly relates to a film laminate with oxygen and/or water vapor barriers. The laminate comprises two layers of metallized thermoplastic film, joined metal surface to metal surface by a layer of adhesive. The two layers of film can comprise one layer of polyolefin and one layer of polyolefin, regenerated cellulose or polyamide. In an embodiment, the polyolefin layer can be LLDPE. The barrier properties of the laminate are said to be substantially better than the sum of the barrier properties of the constituent metallized films.

U.S. Pat. No. 5,888,648 to Donovan, et al. relates to a multilayer film utilizing an outer main film substrate layer, an intermediate layer and a inner sealing layer. The main film substrate can be high-barrier metallized PET, the intermediate layer can be LLDPE, and the sealing layer can be ethylene-propylene random copolymers, ethylene-propylene-butene random terpolymers, or metallocene plastomers. The reference admittedly turns on the provision of both the intermediate and the sealing layers.

Despite the presence of high-barrier films, the prior art does not provide a high-barrier packaging material which has a superior oxygen and moisture barrier, excellent flex-crack, tear, puncture and chemical resistance, good sealing properties and high elongation. Accordingly, it would be useful to provide a packaging material that is useful in meeting these needs.

### SUMMARY OF THE INVENTION

Briefly, therefore, the present invention is directed to a novel high-barrier packaging material for packaging a product. The packaging material comprises at least one outer layer of kraft paper, said outer layer bonded to at least one center layer of high-barrier metallized PET, and said center layer bonded to at least one inner layer of linear low density polyethylene (LLDPE). In the invention, the inner layer is in direct contact with the product.

Among the several advantages found to be achieved by the present invention, it has a superior oxygen and moisture barrier, excellent flex-crack, tear, puncture and chemical resistance, good sealing properties and high elongation. The packaging material of the present invention is also economical to produce.

### BRIEF DESCRIPTION OF THE DRAWINGS

FIG. 1 is an exaggerated cross-section of a high-barrier packaging material of the present invention.

FIG. 2 is an exaggerated cross-section of a high-barrier packaging material of the present invention, wherein the packaging material has two center layers of high-barrier metallized PET.

### DETAILED DESCRIPTION OF THE PREFERRED EMBODIMENTS

Reference now will be made in detail to the embodiments of the invention, one or more examples of which are set forth below. Each example is provided by way of explanation of the invention, not a limitation of the invention. In fact, it will be apparent to those skilled in the art that various modifications and variations can be made in the present invention without departing from the scope or spirit of the invention. For instance, features illustrated or described as part of one embodiment, can be used on another embodiment to yield a still further embodiment.

Thus, it is intended that the present invention covers such modifications and variations as come within the scope of the appended claims and their equivalents. Other objects, features and aspects of the present invention are disclosed in or are obvious from the following detailed description. It is to be understood by one of ordinary skill in the art that the present discussion is a description of exemplary embodiments only, and is not intended as limiting the broader aspects of the present invention.

In accordance with the present invention, a novel high-barrier packaging material for packaging a product has been discovered. The packaging material comprises at least one outer layer of kraft paper, said outer layer bonded to at least one center layer of high-barrier metallized PET, and said center layer bonded to at least one inner layer of linear low density polyethylene (LLDPE). In the invention, the inner layer is in direct contact with the product.

In the present application, the terms “high-barrier” mean any material that is capable of preventing the ingress of another material, such as gases, flavors, vapors or aromas. As used herein, the terms “high-barrier” can mean any material having an oxygen transmission rate of less than about 0.6 cm³/m²/24 hours and a water vapor transmission rate of less than about 0.3 gm²/24 hours.

The terms “outer layer”, as used herein, mean a layer that is positioned on the outside of the packaging material. The outer layer can comprise multiple plies, but for the purposes of this invention, the plies comprise the same material. The terms “center layer” mean a layer that is positioned in the middle of the outer and inner layers. The center layer can comprise multiple plies, but for the purposes of this invention, the plies comprise the same material. The terms “inner layer” mean a layer that is positioned on the inside of the packaging material. The inner layer can comprise multiple plies, but for the purposes of this invention, the plies comprise the same material.

If the packaging material of the present invention is formed into the shape of a bag, designed to contain a product, the inner layer is the layer in direct contact with the product. The term “product”, as used herein, can include any product that would be affected by moisture or gas permeation. For example, “products” may include liquid, solid or powdered food or drinks, pharmaceuticals or nutritional supplements. In certain embodiments, “products” can include powdered dairy formula. In certain other embodiments, “product” can include children or infant formula.

The combination of high-barrier metallized PET and LLDPE in the present invention provides many advantages over the packaging materials of the prior art. Metallized PET is known to improve flex crack resistance, tear resistance and chemical resistance compared to foil-based constructions. LLDPE has good sealing properties, excellent puncture resistance, good optical and mechanical properties, high elongation, excellent impact strength and is highly economical. Thus, the laminate of the present invention provides a packaging material with a combination of these advantages.

In addition, the packaging material of the present invention has an excellent oxygen and vapor barrier. The oxygen barrier provided by the present invention is between about 0.3 and 0.6 cm³/m²/24 hours (at 23° C., 0% RH). The water vapor barrier provided is between about 0.1 and 0.3 gm²/24 hours (at 38° C., 90% RH). These barrier characteristics are better than those exhibited by some of the prior art discussed above.

The present invention utilizes at least one outer layer of kraft paper. In an embodiment, the packaging material comprises two outer layers of kraft paper. In yet another embodiment, the invention comprises three outer layers of kraft paper. In these embodiments, the kraft paper layers can be bonded to one another using polyvinyl acetate.

Kraft paper is made essentially from wood pulp produced by a modified sulfate pulping process. It is a comparatively coarse paper partially noted for its strength. It can be watermarked, striped, calendered, and has an acceptable surface for printing. Its natural unbleached color is brown, but through the use of semi-bleached or fully bleached sulfate pulps it can be produced in lighter shades of brown, cream tints and white.

In the present invention the kraft paper is adhered to a high-barrier metallized PET layer. In an embodiment, the kraft paper can be adhered to the high-barrier metallized PET layer, for example, using hot melt adhesive glue spots. Any adhesive known in the art can be used in this embodiment and other adhering means can be employed. In one embodiment, the adhesive can be the acrylic copolymer Durabond PC8100CM. This pressure sensitive adhesive is available from Revertex Finewaters Sdn Bhd.

The packaging material of the present invention comprises at least one center layer of high-barrier metallized PET. The high-barrier metallized PET center layer comprises two layers of metallized PET, bonded together on a metal surface to metal surface basis. Bonding on a metal surface to metal surface basis protects the metallized surfaces from scratching or scuffing, to avoid surface defects that can affect the barrier properties of the film. The adhesive between the two metal layers of the high-barrier metallized PET can be any known in the art. In one embodiment, a one-component or two-component adhesive can be used, with or without solvents. In a particular embodiment, the adhesive between the two metal layers can be a polyurethane.

The metal layer of the high-barrier metallized PET can deposited onto the PET by any means known in the art. For example, the metal layer can be deposited onto the PET layer through vacuum metallization, physical evaporation, sputtering, indirect metallization, plating, or painting. In an embodiment, the metal layer is deposited onto the PET layer through vacuum metallization.

The metal layer of the metallized PET can comprise various metals, such as aluminum, silver, chromium or combinations thereof. In a particular embodiment, the metal layers of the present invention comprise aluminum.

In an embodiment, the packaging material comprises two center layers of high-barrier metallized PET. Using two center layers of high-barrier metallized PET provides a more effective oxygen and water vapor barrier. The two center layers of high-barrier metallized PET can be bonded together using any bonding agent known in the art to be effective in bonding PET layers. In certain embodiments, the two center layers are bonding using a urethane adhesive.

The present invention also utilizes an inner layer of LLDPE. LLDPE is a copolymer of ethylene with one or more comonomers selected from C₄ to C₁₀ alphaolefins. The molecules of the copolymers comprise long chains with few side chain branches or cross-linked structures. This molecular structure is to be contrasted with conventional low or medium density polyethylenes which are more highly branched than their respective counterparts. LLDPE typically has a density in the range of from about 0.916 g/cm³ to about 0.925 g/cm³. The LLDPE inner layer can be bonded to the high-barrier metallized PET layer using a dry adhesive. In a particular embodiment, the dry adhesive comprises a two-component polyurethane adhesive.

In certain embodiments, the LLDPE inner layer can be substituted with any polyethylene-based material or any plastic which has a sealing property.

The dimensions of the packaging material of the present invention can vary within fairly wide limits. The packaging material must be sufficiently thin to be used as packaging, but also sufficiently thick to have sufficient mechanical resistance to handling. In an embodiment, the thickness of a PET layer is between about 4μ and 300μ. In another embodiment, the thickness of a PET layers is between about 10μ and 200μ. The thickness of an aluminum layer can be between about 0.02μ and 0.06μ. In another embodiment, the thickness of an aluminum layer can be between about 0.03μ and 0.04μ. The adhesive layer between the two metal layers can have a thickness of about 1μ to about 10μ. In another embodiment, the thickness of the adhesive can be between about 2μ and 4μ. Thus, the total thickness of a high-barrier metallized PET layer of the present invention can be between about 8μ and 600μ. In a particular embodiment, a high-barrier metallized PET layer can be between about 10μ and 100μ. In yet another embodiment of the present invention, the thickness of a high-barrier metallized PET layer can be about 12μ.

It is not necessary for the PET layers of the high-barrier metallized PET to have equal thickness. Likewise, it is not necessary for the metal layers of the high-barrier metallized PET to be the same metal or have equal thickness.

The thickness of a LLDPE layer of the present invention can be between about 20μ and 200μ. In an embodiment, the LLDPE layer of the present invention can be between about 30μ and 100μ. In a particular embodiment of the invention, the LLDPE layer can be between about 50μ and 70μ.

A ply of kraft paper used in the present invention can have a thickness of between about 20 g/m² and 100 g/m². In another embodiment, a ply of kraft paper in the present invention is between about 50/m² and 100 g/m². In yet another embodiment, a ply of kraft paper used in the present invention is about 75 g/m².

The packaging material of the present invention can be used to package any product known in the art to require a high moisture and/or oxygen barrier. In an embodiment, the material is used to package a foodstuff, pharmaceutical product, industrial product or agricultural product. Solid, powdered or liquid products can be packaged by the present invention.

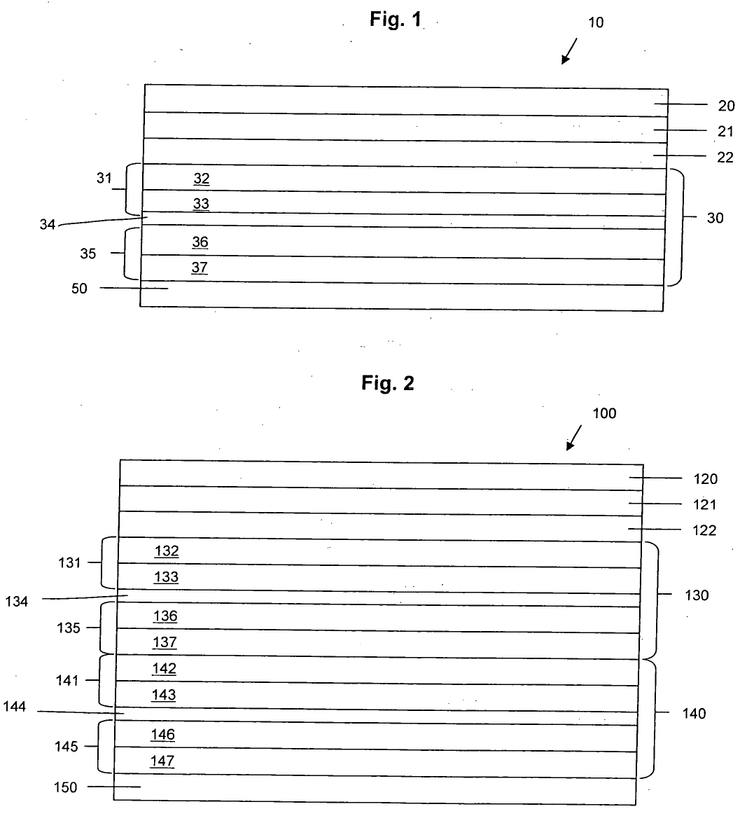

Referring now to the drawings, FIG. 1 illustrates a cross-sectional view of a high-barrier packaging material 10 of the present invention. In this embodiment of the invention, the packaging material has three plies of kraft paper 20, 21, and 22 as the outer layers of the material. In this embodiment, the invention has a single center layer 30 of high-barrier metallized PET. The center layer 30 of high-barrier metallized PET comprises two layers 31 and 35 of metallized PET, where the metal surfaces are bonded together with a layer 34 of polyurethane. Each layer 31 and 35 of metallized PET has a layer 32 and 37 of PET and a layer 33 and 36 of aluminum. The inner layer 50 of the packaging material 10 comprises LLDPE.

FIG. 2 illustrates a cross-section view of a high-barrier packaging material 100 of the present invention in which the packaging material has two center layers 130 and 140 of high-barrier metallized PET. High-barrier metallized PET layer 130 comprises two layers 131 and 135 of metallized PET, bonded with a layer 134 of polyurethane. Similarly, high-barrier metallized PET layer 140 comprises two layers 141 and 145 of metallized PET, bonded with a layer 144 of polyurethane.

In FIG. 2, each metallized PET layer is comprised of a layer of PET and a layer of aluminum. For example, metallized PET layer 131 comprises a layer 132 of PET and a layer 133 of aluminum. Metallized PET layer 135 comprises a layer 137 of PET and a layer 136 of aluminum. Metallized PET layer 141 comprises a layer 142 of PET and a layer 143 of aluminum. Metallized PET layer 145 comprises a layer 147 of PET and a layer 146 of aluminum. The inner layer 150 of the packaging material 100 is LLDPE. The outer layers 120, 121 and 122 of the material are three plies of kraft paper.

The following examples describe various embodiments of the present invention. Other embodiments within the scope of the claims herein will be apparent to one skilled in the art from consideration of the specification or practice of the invention as disclosed herein. It is intended that the specification, together with the examples, be considered to be exemplary only, with the scope and spirit of the invention being indicated by the claims which follow the examples. In the examples, all percentages are given on a weight basis unless otherwise indicated.

### EXAMPLE 1

This example illustrates the preparation of a high-barrier packaging material of the present invention. This example also illustrates the properties of the high-barrier packaging material under testing conditions.

A 12μ layer of high-barrier vacuum-metallized PET was adhered to a 70μ layer of LLDPE using a two-component polyurethane adhesive. Three plies of natural kraft paper (75 g/m²) were then adhered to the opposite side of the high-barrier vacuum-metallized PET using hot melt adhesive glue spots of Durabond PC8100CM to form the packaging material of the present invention. The packaging material was then formed into the shape of a bag, filled with milk powder and sealed. The size of the bag was 865 mm length, 539 mm width, and 164 mm bottom width.

The oxygen barrier of the bag was determined to be about 0.6 cm³/m²/24 hours (at 23° C., 0% RH). The water vapor barrier of the bag was determined to be about 0.3 gm²/24 hours (at 38° C., 90% RH).

The bag was subjected to a drop test using a drop test machine, Drop Tester Model # OSK-02, to ensure bag stability and toughness. The bag was filled with a load of 25 kg and was dropped both vertically and horizontally from a height of 1.0 to 1.5 m. The bag was dropped vertically 10 times and horizontally 10 times. The results were satisfactory, as no breakage was observed.

The bag was subjected to tensile strength testing for the kraft paper and the high-barrier vacuum-metallized PET. The tensile strength testing was accomplished through the use of an autograph machine, Shimadazu Autograph or Tensile Tester, Model # AGS 100C. The kraft paper was tested vertically and horizontally at 10 mm/min, with a gauge length of 100 mm and a sample width of 15 mm. The high-barrier vacuum-metallized PET was tested vertically and horizontally at 300 mm/min, with a gauge length of 100 mm and a sample width of 15 mm. The tensile strength of the kraft paper was determined to be 10.92 kg in the vertical direction and 5.39 kg in the horizontal direction. The tensile strength of the high-barrier vacuum-metallized PET was determined to be 4.47 kg in the vertical direction and 5.03 kg in the horizontal direction. These results were acceptable.

The bag was also tested for sealing, anti-slipping and appearance qualities. The sealing test was conducted using the Shimadazu Autograph or Tensile Tester, Model # AGS 100C and an over-taping machine. These test determine the actual material strength after the sealing process. The material was determined to have a tube strength of 4.54 kg and an over-taping strength of 2.39 kg.

The anti-slipping test was conducted using a slip tester, Yasuda Seiki Slip Tester Model # 162. This test determines the anti-slip angle during transportation. The material was determined to have an anti-slipping value of 37° in both vertical and horizontal directions.

The appearance of the bag was observed with the naked eye and was deemed satisfactory in position, condition and surface as well as printing ability. The printing design, color and character were all observed to be satisfactory.

### EXAMPLE 2

This example illustrates another high-barrier packaging material of the present invention.

Two 12μ high-barrier metallized PET layers were adhered to each other using urethane. In addition, one of the high-barrier metallized PET layers was adhered to a 50μ layer of LLDPE using a two-component polyurethane adhesive. Three plies of natural kraft paper (75 g/m²) were then adhered to the opposite high-barrier vacuum-metallized PET layer using hot melt adhesive glue spots of Durabond PC8100CM. This formed the packaging material of the present invention. The packaging material was then formed into the shape of a bag, filled with milk powder and sealed. The size of the bag was 866 mm length, 540 mm width, and 164 mm bottom width.

The oxygen barrier of the bag was determined to be about 0.3 cm³m²/24 hours (at 23° C., 0% RH). The water vapor barrier of the bag was determined to be about 0.1 gm²/24 hours (at 38° C., 90% RH).

The bag was subjected to a drop test using a drop test machine, Drop Tester OSK-02, to ensure bag stability and toughness. The bag was filled with a load of 25 kg and was dropped both vertically and horizontally from a height of 1.0 to 1.5 m. The bag was dropped vertically 10 times and horizontally 10 times. The results were satisfactory, as no breakage was observed.

The bag was subjected to tensile strength testing for the kraft paper and the high-barrier vacuum-metallized PET. The tensile strength testing was accomplished through the use of an autograph machine, Shimadazu Autograph or Tensile Tester, Model # AGS 100C. The kraft paper was tested vertically and horizontally at 10 mm/min, with a gauge length of 100 mm and a sample width of 15 mm. The high-barrier vacuum-metallized PET was tested vertically and horizontally at 300 mm/min, with a gauge length of 100 mm and a sample width of 15 mm. The tensile strength of the kraft paper was determined to be 10.08 kg in the vertical direction and 4.85 kg in the horizontal direction. The tensile strength of the high-barrier vacuum-metallized PET was determined to be 7.68 kg in the vertical direction and 8.92 kg in the horizontal direction. These results were acceptable.

The bag was also tested for sealing, anti-slipping and appearance qualities. The sealing test was conducted using the Shimadazu Autograph or Tensile Tester, Model # AGS 100C and an over-taping machine. These test determine the actual material strength after the sealing process. The material was determined to have a tube strength of 6.52 kg and an over-taping strength of 4.90 kg.

The anti-slipping test was conducted using a slip tester, Yasuda Seiki Slip Tester Model# 162. This test determines the anti-slip angle during transportation. The material was determined to have an anti-slipping value of 34 to 35° in both vertical and horizontal directions.

The appearance of the bag was observed with the naked eye and was deemed satisfactory in position, condition and surface as well as printing ability. The printing design, color and character were all observed to be satisfactory.

All references cited in this specification, including without limitation, all papers, publications, patents, patent applications, presentations, texts, reports, manuscripts, brochures, books, internet postings, journal articles, periodicals, and the like, are hereby incorporated by reference into this specification in their entireties. The discussion of the references herein is intended merely to summarize the assertions made by their authors and no admission is made that any reference constitutes prior art. Applicants reserve the right to challenge the accuracy and pertinence of the cited references.

Although preferred embodiments of the invention have been described using specific terms, devices, and methods, such description is for illustrative purposes only. The words used are words of description rather than of limitation. It is to be understood that changes and variations may be made by those of ordinary skill in the art without departing from the spirit or the scope of the present invention, which is set forth in the following claims. In addition, it should be understood that aspects of the various embodiments may be interchanged both in whole or in part. For example, while methods for the production of a commercially sterile liquid nutritional supplement made according to those methods have been exemplified, other uses are contemplated. Therefore, the spirit and scope of the appended claims should not be limited to the description of the preferred versions contained therein.

What is claimed is:

1. A high-barrier packaging material for packaging a product, the packaging material comprising:
a) at least one outer layer of kraft paper,
b) said outer layer bonded to at least one center layer of high-barrier metallized polyethylene terephthalate,
c) said center layer bonded to at least one inner layer of linear low density polyethylene, said inner layer being in direct contact with said product.

2. The packaging material according to claim 1, wherein said center layer of high-barrier metallized polyethylene comprises two layers of metallized polyethylene terephthalate, bonded together on a metal surface to metal surface basis.

3. The packaging material according to claim 2, wherein metal surfaces are bonded together using a polyurethane adhesive.

4. The packaging material according to claim 1, comprising two outer layers of kraft paper.

5. The packaging material according to claim 1, comprising three outer layers of kraft paper.

6. The packaging material according to claim 1, comprising two center layers of high-barrier metallized polyethylene terephthalate.

7. The packaging material according to claim 1, wherein the high-barrier metallized polyethylene terphthalate is metallized through vacuum metallization.

8. The packaging material according to claim 1, wherein the metal layer of the high-barrier metallized polyethylene terephthalate comprises aluminum.

9. The packaging material according to claim 1, wherein the packaging material is used to package a foodstuff, pharmaceutical product, industrial product or agricultural product.

10. The packaging material according to claim 1, wherein the packaging material is formed into the shape of a bag.

11. The packaging material according to claim 1, wherein the thickness of the high-barrier metallized PET layer is between about 8μ and 600μ.

12. The packaging material according to claim 1, wherein the thickness of the high-barrier metallized PET layer is between about 10μ and 100μ.

13. The packaging material according to claim 1, wherein the thickness of the high-barrier metallized PET layer is about 12μ.

14. The packaging material according to claim 1, wherein the thickness of the LLDPE layer is between about 20μ and 200μ.

15. The packaging material according to claim 1, wherein the thickness of the LLDPE layer is between about 30μ and 100μ.

16. The packaging material according to claim 1, wherein the thickness of the LLDPE layer is between about 50μ and 70μ.

17. The packaging material according to claim 1, wherein the weight of the kraft paper is between about 20 g/m² and 100 g/m².

18. The packaging material according to claim 1, wherein the weight of the kraft paper is about 75 g/m².
